(19) United States
(12) Patent Application Publication
(10) Pub. No.: US 2024/0288276 A1
(43) Pub. Date: Aug. 29, 2024

(54) Systems and Methods For Destination Navigation

(71) Applicant: APPLE INC., Cupertino, CA (US)

(72) Inventors: Sung Chang Lee, Saratoga, CA (US); Kenneth H. Mahan, Santa Clara, CA (US); Ki Myung Lee, Palo Alto, CA (US); Nigel J. Funge, Redwood City, CA (US); Richard J. Blanco, San Francisco, CA (US)

(21) Appl. No.: 18/585,114

(22) Filed: Feb. 23, 2024

Related U.S. Application Data
(60) Provisional application No. 63/487,095, filed on Feb. 27, 2023.

(51) Int. Cl. G01C 21/36; B60W 30/18; B60W 50/14; B60W 50/16; G06V 20/56

(52) U.S. Cl. CPC G01C 21/3658; B60W 30/18163; B60W 50/16; G01C 21/3602; G01C 21/3647; G06V 20/588; B60W 2050/143; B60W 2050/146; B60W 2420/403; B60W 2520/10; B60W 2554/406; B60W 2554/80

(57) ABSTRACT

A method includes obtaining a navigation instruction that is associated with a first location along a roadway, wherein the roadway defines multiple lanes, and the navigation instruction specifies a first lane from the multiple lanes. The method also includes obtaining a first image of the roadway from an imaging device that is located with a vehicle that is travelling along the roadway toward the first location, determining, based on the first image, that the vehicle is located in a second lane from the multiple lanes, and in response to determining that the vehicle is located in the second lane, outputting a first notification that instructs a driver of the vehicle to move the vehicle to the first lane.

### CROSS-REFERENCE TO RELATED APPLICATIONS

This application claims the benefit of, and priority to, U.S. Provisional Application No. 63/487,095, filed on Feb. 27, 2023, the content of which is hereby incorporated by reference herein for all purposes.

### FIELD

The present disclosure relates generally to the field of navigation systems.

### BACKGROUND

Known navigation systems provide information about a route from an origin to a destination. Such navigation systems may provide turn-by-turn navigation instructions during travel toward the destination.

### SUMMARY

A first aspect of the disclosure is a non-transitory computer-readable storage device including program instructions executable by one or more processors that, when executed, cause the one or more processors to perform operations. The operations include obtaining a navigation instruction that is associated with a first location along a roadway, wherein the roadway defines multiple lanes, and the navigation instruction specifies a first lane from the multiple lanes. The operations also include obtaining a first image of the roadway from an imaging device that is located with a vehicle that is travelling along the roadway toward the first location, determining, based on the first image, that the vehicle is located in a second lane from the multiple lanes, and in response to determining that the vehicle is located in the second lane, outputting a first notification that instructs a driver of the vehicle to move the vehicle to the first lane. In an implementation, the imaging device is a camera that is incorporated in a personal electronic device, such as a cellular telephone, and the notification may be output by the personal electronic device.

In some implementations, outputting the first notification is performed when a distance between the vehicle and the first location is less than a first threshold distance. The first threshold distance may be determined based on a speed of the vehicle. The first threshold distance may be determined based on a traffic condition on the roadway.

In some implementations, the imaging device is powered off when a distance between the vehicle and the first location is greater than a second threshold distance, and the imaging device is powered on in order to obtain the first image when the distance between the vehicle and the first location is less than the second threshold distance. The second threshold distance may be greater than the first threshold distance.

Some implementations include, subsequent to outputting the first notification, obtaining a second image of the roadway from the imaging device, determining, based on the second image, that the vehicle has moved from the second lane to the first lane, and in response to determining that the vehicle has moved to the first lane, outputting a second notification that indicates that the vehicle is positioned correctly.

The first notification may include an audio notification. The first notification may include a visual notification. The first notification may include a haptic notification. The first notification may be output using an output device associated with the vehicle. The first notification may be output using a personal electronic device that is associated with the driver of the vehicle, and the personal electronic device incorporates the imaging device. In some implementations, obtaining the navigation instruction, obtaining the first image, determining that the vehicle is located in the second lane, and outputting the first notification are performed by the personal electronic device. In some implementations, the first notification is output using a wearable device that is worn by the driver of the vehicle. In some implementations, the imaging device is integrated with the vehicle.

A second aspect of the disclosure is an apparatus that includes a memory, and one or more processors that are configured to execute instructions that are stored in the memory. The instructions, when executed, cause the one or more processors to obtain a navigation instruction that is associated with a first location along a roadway, wherein the roadway defines multiple lanes, and the navigation instruction specifies a first lane from the multiple lanes. The instructions further cause the one or more processors to obtain a first image of the roadway from an imaging device that is located with a vehicle that is travelling along the roadway toward the first location, determine, based on the first image, that the vehicle is located in a second lane from the multiple lanes, and in response to determining that the vehicle is located in the second lane, output a first notification that instructs a driver of the vehicle to move the vehicle to the first lane.

A third aspect of the disclosure is a method that includes obtaining a navigation instruction that is associated with a first location along a roadway, wherein the roadway defines multiple lanes, and the navigation instruction specifies a first lane from the multiple lanes. The method also includes obtaining a first image of the roadway from an imaging device that is located with a vehicle that is travelling along the roadway toward the first location, determining, based on the first image, that the vehicle is located in a second lane from the multiple lanes, and in response to determining that the vehicle is located in the second lane, outputting a first notification that instructs a driver of the vehicle to move the vehicle to the first lane.

### BRIEF DESCRIPTION OF THE DRAWINGS

FIG. 1 is a block diagram of a navigation system.

FIG. 2A is a schematic illustration showing implementation of the navigation system using an infotainment system of a vehicle.

FIG. 2B is a schematic illustration showing implementation of the navigation system using an infotainment system of a vehicle and a personal device.

FIG. 2C is a schematic illustration showing implementation of the navigation system using a personal device.

FIG. 3 is a block diagram of a lane confirmation subsystem of the navigation system.

FIG. 4 is a schematic illustration of a roadway.

FIG. 5 is a block diagram of a process for navigation with lane confirmation.

FIG. 6 is a block diagram of an example computing device.

### DETAILED DESCRIPTION

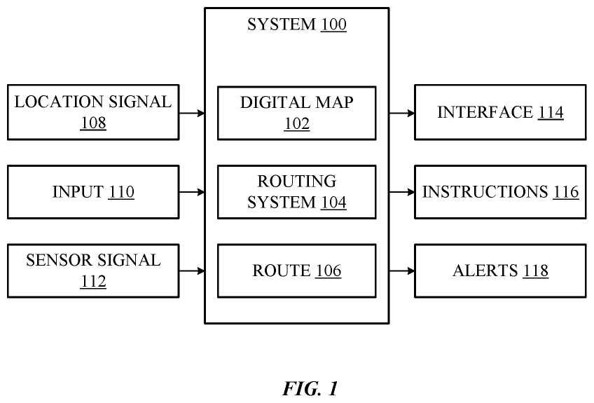

FIG. 1 is a block diagram of a navigation system 100. The navigation system 100 may be implemented in the form of computer program instructions and associated information. The computer program instructions are executed by a computing device, such an example computing device 690 of FIG. 6. In the illustrated implementation, the navigation system 100 includes a digital map 102 and a routing system 104 that is configured to determine a route 106 based on an input 108 that is provided by a user. The navigation system 100 receives a location signal 110 and a sensor signal 112 (or multiple sensor signals) as inputs. The navigation system 100 is also configured to generate outputs in order to present the outputs to the user and thereby present information to the user. As examples, the outputs of the navigation system 100 may include a navigation interface 114, navigation instructions 116, and notifications 118.

The digital map 102 is a collection of mapping information that is encoded in a computer-interpretable form. The digital map 102 may include an encoded a representation of a transportation network, including representations of pedestrian pathways, bicycle pathways, and roads. As an example, information describing a segment of a transportation network may be stored in an encoded form that includes geospatial coordinates describing the location and extents of the segment, such as a starting point and an ending point of the segment expressed as latitude, longitude, and elevation coordinates. Additional information about the segment may be encoded and included in the mapping information, such as information describing regulations that apply to the segment, and traffic control devices located at the segment. The digital map 102 may also include cost information that is associated with segments, such as information describing length, travel time, traffic conditions, and so forth, for use by the routing system 104 during determination of the route 106. The digital map 102 also includes information describing connectivity between segments. As an example, each of the segments can be assigned a unique identifier, such as a numeric code, and the information describing each segment may describe connections to other segments by reference to their unique identifiers. As one example, the digital map 102 may define a graph structure in which the segments of the digital map 102 correspond to edges of the graph, and connections between the segments of the digital map 102 correspond to nodes of the graph.

The routing system 104 is configured to determine the route 106 using the mapping information from the digital map 102. The route 106 may be determined based on the input 108. As one example, the input 108 may include information identifying an origin location (which may be a current location of a device that implements the navigation system 100), and information identifying a destination location. The input 108 may be a user input received from the user in any suitable form, such as a voice command that is interpreted using a speech recognition function, a text input entered using a keyboard or other suitable device, or a touch input made using a touch-sensitive display screen.

The routing system 104 may determine the route 106 between a first location and a second location (e.g., as specified by the input 108) using the digital map 102 and a routing algorithm that is configured to determine a route between to locations. As an example, in an implementation in which the digital map represents a transportation network as a graph structure, the routing system 104 may utilize a routing algorithm to determine the route 106 as a series of connected edges between a first edge of the graph structure that represents the origin location, and a second edge of the graph structure that represents the destination location. The routing algorithm used to determine the route 106 may utilize cost information, for example, from the digital map 102, to determine the route 106 based in part on a cost function. As one example, the routing algorithm used by the routing system 104 to determine the 106 may be or include Dijkstra's algorithm. Other routing algorithms may be used.

The location signal 110 is used to monitor the location of the device on which the navigation system 100 is implemented. As an example, the location signal 110 may be or include geospatial coordinates, which can be compared to the digital map 102 and the route 106. During navigation using the route 106 the location signal 110 may be used to determine the current location of the device that includes the navigation system 100. As an example, the location signal 110 may be output by a location subsystem (e.g., including a satellite positioning receiver) of the device on which the navigation system 100 is implemented. The location signal 110 may be used by the routing system 104, for example, to set an origin destination for a routing request to a current location of the device incorporating the navigation system 100, or to monitor the location of the device incorporating the navigation system 100 during navigation using the route 106, for example, in order to allow the navigation system 100 to output the navigation instructions at appropriate times.

The sensor signal 112 is a signal received from a sensor device of any type. The sensor signal 112 may be provided to the navigation system 100 by the device on which the navigation system 100 is implemented. The sensor signal may be provided to the navigation system 100 by another device that is colocated with and able to transmit the sensor signal 112 to the navigation system 100, for example, using a wired or wireless data transmission connection. The sensor signal 112 may represent an observation (e.g., measurement, image, so forth) of an environment around the device on which the navigation system 100 is implemented. As one example, the sensor signal 112 may include an image (e.g., a digital image comprising an array of pixels) that is obtained by an imaging device, such as a still camera or a video camera, including visible spectrum cameras and infrared spectrum cameras. As another example, the sensor signal 112 may include information describing the locations of one or more physical objects in the environment, such as an ultrasonic sensor signal, a radar sensor signal (e.g., including imaging radar), a lidar sensor signal (e.g., a point cloud), and so forth.

Although the sensor signal 112 is referred to in singular form, it should be understood that the sensor signal 112 may include multiple sensor signals. As an example, the navigation system 100 may receive multiple sensor signals from a single sensor, for example, representing multiple observations made by the sensor over time. As an example, the navigation system 100 may one or more sensor signals from each of multiple sensors.

The navigation interface 114 is an output of the navigation system 100, and includes a visual representation of information generated by the navigation system 100. The navigation interface 114 may include a visual representation of the digital map 102, and the current location of the device incorporating the navigation system 100 may be included in the navigation interface 114, for example, as an icon located on the visual representation of the digital map 102. The navigation interface 114 may also include a visual representation of information based on the navigation instructions 116. As an example, the navigation instructions 116 may be or include turn-by-turn style instructions that describe, to the user of the navigation system 100, how to follow the route 106. A visual representation of the navigation instructions 116 may include, as examples, descriptive text, icons, arrows indicating directions, a graphical representation of the lane configuration of a roadway, and so forth.

The notifications 118 are outputs of the navigation system 100 that are intended to inform the user of a circumstance relating to operation of the navigation system 100. As an example, the notifications 118 may provide information to the driver regarding an action that needs to be taken based on the navigation instructions 116. The notifications 118 may include, as examples, visual notifications that are output using a display screen, audible notifications that are output using an audio output device such as a loudspeaker, and haptic notifications that are output using a haptic device feedback device, for example, that outputs vibration according to a recognizable pattern.

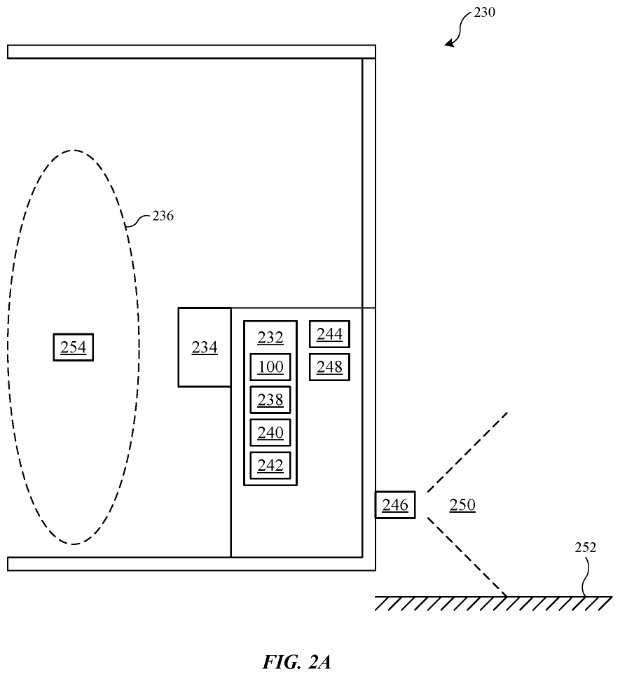

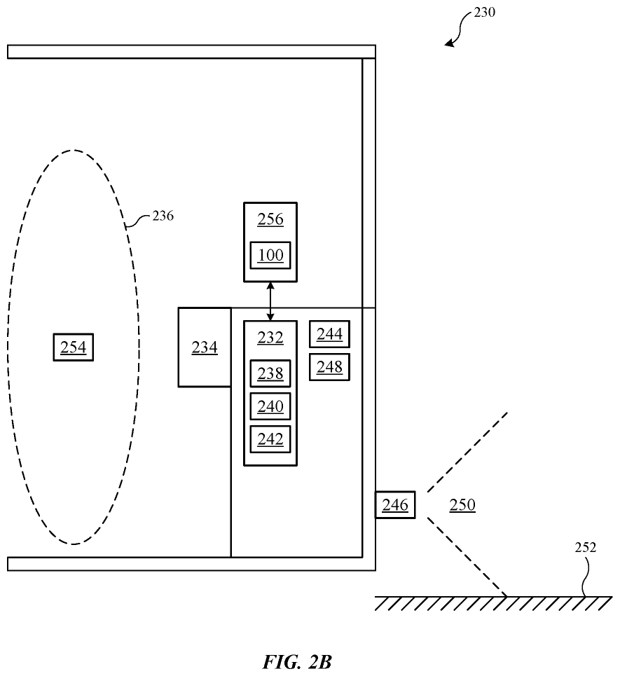

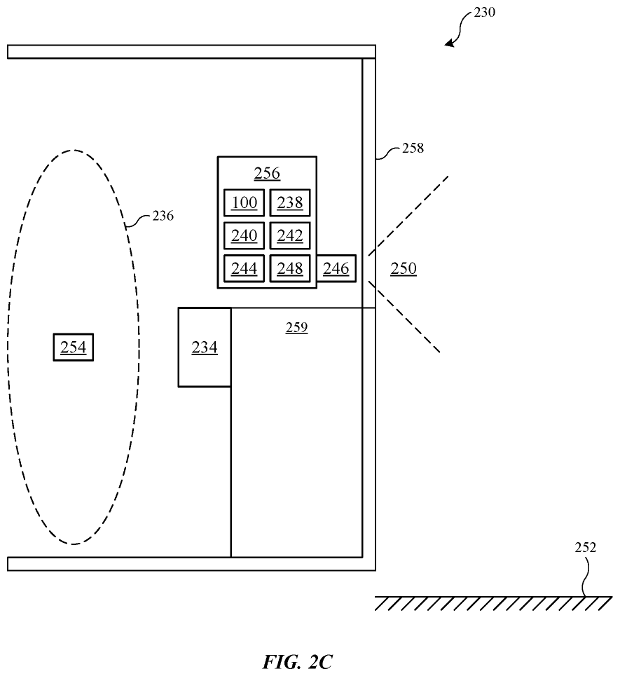

FIG. 2A is a schematic illustration showing implementation of the navigation system 100 in a vehicle 230 using an infotainment system 232 of the vehicle. The navigation system 100 may be provided to the infotainment system 232 of the vehicle 230 as software that is executed by the infotainment system 232. To implement functionality of the navigation system 100, the infotainment system 232 includes a computing device, such as the example computing device 690 of FIG. 6. In this example, the navigation system 100 utilizes components and functionality of the infotainment system 232, for example, to receive the input 108, and to present the navigation interface 114, the navigation instructions 116, and the notifications 118. The navigation system 100 utilizes components and functionality of the vehicle 230, for example, to obtain the location signal 110 and the sensor signal 112.

Vehicle 230 may have conventional systems that are able to cause and control motion of the vehicle, such as a propulsion system, a braking system, a steering system, a suspension system, and so forth. Operator controls 234 are included in the vehicle 230 to allow operation of the vehicle 230. As examples, a driver 236 may use the operator controls 234 to steer the vehicle 230, accelerate the vehicle 230, and decelerate the vehicle 230.

To receive inputs from the driver 236 and to present outputs to the driver 236, the infotainment system 232 may include a display screen 238, an audio input device 240, and an audio output device 242. Other conventional input and output devices may also be incorporated in the infotainment system 232 and/or otherwise be made available for use by the navigation system 100.

The display screen 238 may be implemented, for example, as a light-emitting display of any suitable type, such as an LED display screen or an OLED display screen. The display screen 238 is configured to receive an output from the navigation system 100 that includes visual content in a format that can be output for display to the driver 236 using the display screen 238. The content output for display to the display screen 238 by the navigation system 100 may include the navigation interface 114, the navigation instructions 116, and the notifications 118 when output in the form of visual notifications. In some implementations, the display screen 238 may be a touch sensitive display screen that is able to output signals representing user inputs, for example, for use by the navigation system 100 as the input 108. Other input devices may alternatively be incorporated in the infotainment system 232 or may incorporated in the vehicle 230 and be available for use by the infotainment system 232, such as buttons and knobs. The audio input device 240 may be a microphone or other conventional device that is able to perceive sounds in the environment around it, and may record audio that includes commands spoken by the driver 236, and these spoken commands may be interpreted using voice recognition software to generate the input 108 for the navigation system 100. The audio output device 242 may be a loudspeaker or other convention device that is able to receive a signal output by the navigation system 100 and output corresponding audio so that it may be heard by the driver 236. As an example, the navigation system 100 may use the audio output device 242 to output audio corresponding to the navigation instructions 116 or the notifications 118 (e.g., audio notifications).

The satellite positioning receiver 244 is configured to output geospatial coordinates that describe its location, for example, based on signals received from satellites. The satellite positioning receiver 244 may be implemented according to conventional designs. In this implementation, the satellite positioning receiver 244 is a component of the vehicle 230 and is configured to output the location signal 110, for example, including coordinates describing the location of the satellite positioning receiver 244, to the infotainment system 232 for use by the navigation system 100.

The sensor 246 is a component that is configured to perceive the environment around the vehicle 230 and to output a signal representing an observation of the environment. As an example, the sensor 246 may have a field of view 250 that includes a portion of the environment around the vehicle 230, including a portion of a roadway 252. The output of the sensor 246 is consistent with the sensor signal 112 as previously describes and is usable by the navigation system 100 as the sensor signal 112 in this implementation. The sensor 246 may, in some implementations, output multiple sensor signals and/or include multiple sensors of a common type or multiple sensors of different types. In this implementation, the sensor 246 is a component of the vehicle 230 and is configured to output the sensor signal 112 to the infotainment system 232 for use by the navigation system 100. As an example, the sensor 246 may be a video or still camera able to obtain visible spectrum or infrared spectrum images (e.g. digital images and/or digital video frames) and to output the images to the navigation system 100 as the sensor signal. The sensor 246 may alternatively be a different type of sensor operable to output a signal corresponding to an observation of the environment, such as an ultrasonic sensor, a radar sensor, or a lidar sensor, and the signal may be output to the navigation system 100 in a suitable form for use as the sensor signal 112.

The haptic feedback generator 248 is a component that is able to generate a haptic output, such as force, vibration, or motion having a recognizable pattern, and which indicates information about a circumstance to a user, such as the driver 236 of the vehicle 230 in the current example. The haptic feedback generator 248 may be operated by the signal output by the navigation system 100. The haptic feedback generator 248 may be implemented using a variety of suitable components, such as an electric motor coupled to an eccentric rotating mass, a piezoelectric actuator, or other suitable component. In this implementation, the haptic feedback generator 248 is a component of the vehicle 230 and is configured to output the notifications 118 in the form of haptic notifications. As an example, one or more of the operator controls 234 of the vehicle 230 may be equipped with an electric motor that is controllable by the navigation system 100 to generate a haptic output. As an example, an actuator system of the vehicle 230 may be controllable by the navigation system 100 to generate the haptic output of the haptic feedback generator 248. As an example, a movement actuator for a seat of the vehicle 230 that the driver 236 is sitting in may be controllable by the navigation system 100 to generate the haptic output of the haptic feedback generator 248.

The navigation system 100 may also communicate with a wearable electronic device 254 by means of a wireless data connection, in order to receive inputs and/or present outputs to the driver 236 using the wearable electronic device 254. As an example, an audio input (e.g., including a command spoken by the driver 236) may be received by the wearable electronic device and relayed to the infotainment system 232 for use by the navigation system 100. As an example, the notifications 118 may be output at the wearable electronic device 254, inclusive of visual notifications, audible notifications, and haptic notifications.

FIG. 2B is a schematic illustration showing implementation of the navigation system 100 using the infotainment system 232 of the vehicle 230 and a personal device 256. The personal device 256 is provided with navigation system 100 and is configured to implement the functions previously described with respect to the navigation system 100. The personal device 256 may be a smart telephone or similar device, and incorporates a computing device, such as the example computing device 690 of FIG. 6. The personal device 256 may execute computer program instructions that implement the navigation system 100 and may utilize components associated with the vehicle 230, the infotainment system 232, and/or the personal device 256 for input and output functions. The personal device 256 is in communication with the infotainment system 232 and optionally with other components of the vehicle 230, such as by a wired or wireless communications connection, in order to allow inputs to be received by the personal device 256 from the vehicle 230 and the infotainment system 232 for use by the navigation system 100, and to allow the navigation system to present outputs to the driver 236 using components of the vehicle 230 and the infotainment system 232.

In the illustrated implementation, for example, execution of software corresponding to the navigation system 100 is performed by the personal device 256, and components of the vehicle 230 and the infotainment system 232 are used for some or all input and output functions. As an example, the input 108, the location signal 110, and the sensor signal 112 may be obtained using the infotainment system 232, the satellite positioning receiver 244, the sensor 246, and/or other components of the infotainment system 232 and/or the vehicle 230, and these inputs and signals are provided to the personal device 256 for use by the navigation system 100. Outputs, such as the navigation interface 114, the navigation instructions 116, and the notifications 118 may be presented using components of the infotainment system 232 and/or the vehicle 230, such as the display screen 238, the audio output device 242, and the haptic feedback generator 248. Thus, for example, the sensor 246 of the vehicle 230 is used to obtain the sensor signal 112, such as an image obtained by an imaging device, and the sensor signal 112 is transmitted from the sensor 246 of the vehicle 230 to the personal device 256 by a wired or wireless data connection for use by the navigation system 100. Operation of the navigation system 100 in the implementation of FIG. 2B is otherwise as described with respect to the implementation shown in FIG. 2A.

FIG. 2C is a schematic illustration showing implementation of the navigation system 100 using the personal device 256. The personal device 256 is provided with navigation system 100 and is configured to implement the functions previously described with respect to the navigation system 100. In this implementation, the display screen 238, the audio input device 240, the audio output device 242, the satellite positioning receiver 244, the sensor 246, and the haptic feedback generator 248 are incorporated in the personal device 256, and these devices are utilized by the navigation system 100, which is executed at the personal device 256. Components of the vehicle 230 and/or the infotainment system 232 may also be used by the navigation system 100 when implemented on the personal device 256.

In this implementation, the sensor 246 of the personal device 256 is used to obtain the sensor signal 112, such as an image obtained by an imaging device, and the sensor signal 112 is then available for use by the navigation system 100. To allow the sensor 246 to obtain information representing an observation of the environment around the vehicle 230, such as the roadway 252, the personal device 256 may be mounted adjacent to a front window 258 of the vehicle 230, such as by mounting the personal device 256 on an instrument panel 259 of the vehicle 230 so that the field of view 250 of the sensor 246 is oriented through the front window 258 and thereby includes a view of the roadway 252.

Embodiments of the present navigation system utilize a navigation instruction that identifies an action that needs to be taken at a location. The action may include, as examples, turning at an intersection or exiting a limited-access highway at an interchange. Based on the navigation instruction, the navigation system determines which lane from a multiple lane roadway a vehicle should be positioned in prior to arriving at the location. Using a sensor signal, such as an image, the navigation system determines whether the vehicle is positioned in the correct lane. If the vehicle is not positioned in the correct lane, the navigation system outputs a notification that instructs the driver of the vehicle to change lanes and thereby position the vehicle in the correct lane.

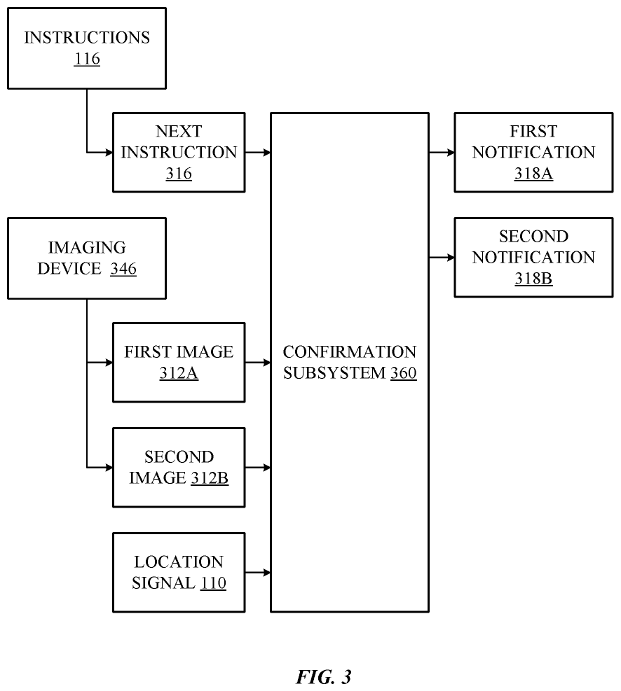

FIG. 3 is a block diagram of a lane confirmation subsystem 360 of the navigation system 100. The lane confirmation subsystem 360 operates while the vehicle 230 is being operated by the driver 236 under manual control using the route 106. While following the route, the lane confirmation subsystem 360 identifies a next navigation instruction 316 to be followed from the navigation instructions 116. If the next navigation instruction 316 requires the vehicle 230 to be in a specific lane of the roadway 252, the lane confirmation subsystem 360 determines whether the vehicle 230 is in the correct lane prior to the location (e.g., a first location) at the which the next navigation instruction 316 directs the driver 236 to control the vehicle 230 in a particular way (e.g., by turning or transitioning onto a freeway ramp) in order to continue following the route 106.

The lane confirmation subsystem 360 determines a location (e.g., a second location) at which to check whether the vehicle 230 is in the correct lane, and provide a notification to the driver 236 if the vehicle 230 is not in the correct lane. The second location is spaced from the first location by a first threshold distance, such that the lane confirmation subsystem 360 checks whether the vehicle 230 is in the correct lane when the distance from the vehicle 230 to the first location, which corresponds to the next navigation instruction 316, is less than the first threshold distance. As one example, the first threshold distance may be a predetermined distance. As another example, the first threshold distance may be determined based on the speed of the vehicle 230 of the regulatory speed (e.g., the speed limit) for the roadway 252, such as by using a function that establishes a relationship between speed of the vehicle 230 and the first threshold distance (e.g., using a ratio of speed to distance subject to minimum and maximum bounds for the first threshold distance). As another example, the first threshold distance may be determined in part based on traffic conditions on the roadway 252, such as by setting the first threshold distance as a predetermined distance or speed-based distance, and then adjusting the first threshold distance upward by a factor that accounts for traffic conditions. As another example, the first threshold distance may be determined in part based on the driving style or preferences of the driver 236, such as by setting the first threshold distance as a predetermined distance or speed-based distance, and then adjusting the first threshold distance upward by a factor that accounts for the driver 236.

When the vehicle 230 reaches the second location, the lane confirmation subsystem 360 receives the sensor signal 112, which in the illustrated implementation is a first image 312a obtained by an imaging device 346, such as a camera of any suitable type. The first image 312a shows a portion of the roadway 252 is interpreted by the lane confirmation subsystem 360 to identify lanes of the roadway 252. To interpret the first image 312a, the lane confirmation subsystem 360 may use conventional machine vision techniques. As one example, the first image 312a may be processed using an edge finding algorithm that identifies discontinuities in color and/or brightness in the first image 312a and generates edges according to those discontinuities. The generated edges may then be filtered, for example, by linearity, length, angle, and position, to identify edges corresponding to lane boundaries and then determine that the spaces between them are lanes. This process may alternatively be performed by other types of systems, such as a trained neural network. Once the lanes are identified in the first image 312a, the lanes are correlated to the lanes identified in the digital map 102 at the current location of the vehicle 230 and/or in the next navigation instruction 316. Although the first image 312a is described as a single image, multiple images may be obtained and analyzed repeatedly over time.

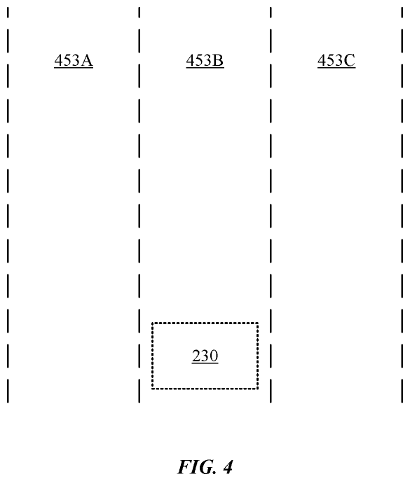

In FIG. 4, which is a schematic illustration of the roadway 252 as perceived by the lane confirmation subsystem 360 using the first image 312a, the roadway 252 includes a left lane 453a, a center lane 453b, and a right lane 453c, with the vehicle 230 being positioned in the center lane 453b, and with the right lane 453c being the lane identified by the next navigation instruction 316 as the correct lane for the vehicle 230 to be positioned in. Based on analysis of the first image 312a and comparison of the position of the vehicle 230 to the position directed by the next navigation instruction 316, the lane confirmation subsystem 360 may determine that the vehicle 230 is not positioned in the correct lane, for example, by being positioned in the center lane 453b instead of being positioned in the right lane 453c. In response to this determination, the lane confirmation subsystem 360 outputs a first notification 318a, which is one of the notifications 118 and may be output as previously described. The first notification 318a tells the driver 236 that the vehicle 230 is not positioned in the correct lane, and the first notification 318a may tell the driver 236 which lane the vehicle 230 should be positioned in. After the first notification 318a is output, the lane confirmation subsystem 360 obtains a second image 312b and uses the second image 312b to determine whether the vehicle 230 has moved to the lane specified by the next navigation instruction 316. Obtaining and analyzing the second image 312b may be performed in the manner described with respect to the first image 312a. Although the second image 312b is described as a single image, multiple images may be obtained and analyzed repeatedly over time. When the lane confirmation subsystem 360 determines, based on the second image 312b, that the vehicle 230 is now positioned in the lane that is specified by the next navigation instruction 316, the lane confirmation subsystem 360 may output a second notification 318b that indicates that the vehicle is positioned correctly.

The first notification 318a and the second notification 318b may be visual notifications such as graphical notifications or text notifications, audible notifications such as sound effects or speech notifications, or haptic notifications output by the vehicle 230, the wearable electronic device 254, or the personal device 256. Other types of notifications may be used to provide information to the driver 236, and the notifications may be output by other types of devices.

In some implementations, the sensor 246, such as the imaging device 346, that is used to obtain the sensor signal 112, such as the first image 312a or the second image 312b, may be turned off to conserve energy when it is not needed. This may be particularly useful, for example, when the sensor 246 is incorporated in the personal device 256, which may be battery-operated. In such implementations, the imaging device 346 or other sensor used by the lane confirmation subsystem 360 is powered off when a distance between the vehicle 230 and the first location is greater than a second threshold distance. When the vehicle 230 reaches a location corresponding to the second threshold distance, the imaging device is powered on in order to obtain the first image when the distance between the vehicle 230 and the first location is less than the second threshold distance. The second threshold distance corresponds to a location at or prior to the first threshold distance, to allow the imaging device 346 or other sensor to turn on prior to the time at which the first image 312a will be captured. The second threshold distance may be greater than the first threshold distance, or may be equal to the first threshold distance. It should be understood that “powered off” corresponds to a power level at which the imaging device 346 or other sensor is not able to output sensor signals, such as images, without first switching to a normal power mode (corresponding to being “powered on”) and thus, “powered off” may include a low power mode in which there is some power consumption by the imaging device 346 or other sensor.

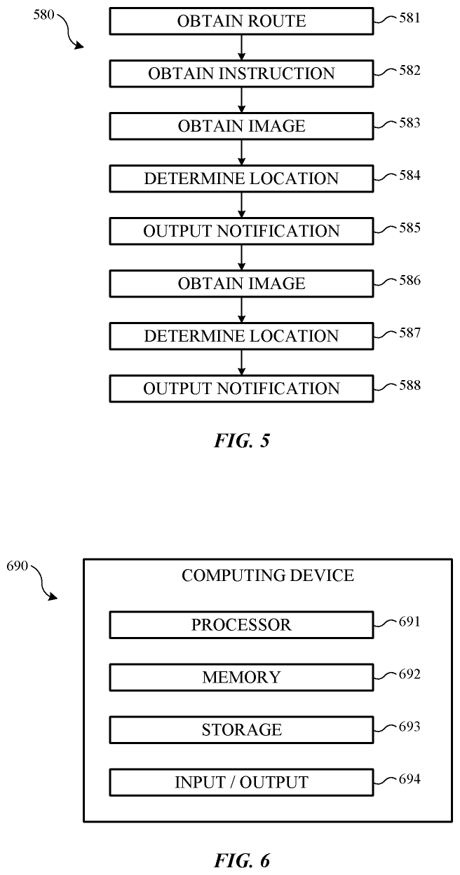

FIG. 5 is a block diagram of a process 580 for navigation with lane confirmation. The process 580 may be implemented in the context of the navigation system 100. As an example, the process 580 or portions of the process 580 may be implemented by one or more computing devices from the vehicle 230, the infotainment system 232, the wearable electronic device 254, and the personal device 256. The computing devices of these systems may be configured to perform the operations of the process 580, for example, using the example computing device 690 of FIG. 6. As an example, the process 580 the steps thereof may be implemented in the form of computer program instructions that are executable by one or more computing devices, wherein the instructions, when executed by the one or more computing devices, cause the one or more computing devices to perform functions that correspond to the steps of the process. As an example, the process 580 and the steps thereof may be implemented in the form of a non-transitory computer-readable storage device including program instructions executable by one or more processors that, when executed, cause the one or more processors to perform operations that correspond to the steps of the process 580.

Operation 581 includes obtaining a route, such as the route 106, from an origin location to a destination location. The origin location and the destination location may be supplied to the navigation system 100 by the driver 236, for example, as described with respect to the input 108. Obtaining the route 106 from the origin location to the destination location may include sending a request to a remote server that performs routing functions (e.g., using a routing algorithm and cost information in combination with a digital map in the form of a routing graph), and receiving the route 106 in response. Obtaining the route 106 from the origin location to the destination location may include determining the route locally, by the navigation system 100 using the digital map 102 and the routing system 104 as previously described. Obtaining the route 106 from the origin location to the destination location may accessing a previously stored route for use as the route 106. Other implementations of obtaining a route are possible.

Subsequent to obtaining the route 106, the vehicle 230 may be driven under manual control by the driver 236 according to the route 106. In some implementations, the vehicle 230 may be configured for partial automated control, and portions of the route 106 may be travelled under automated control.

Operation 582 includes obtaining a navigation instruction that is associated with a first location along a roadway, such as the roadway 252. The navigation instruction obtained in operation is one of the navigation instructions 116, such as the next navigation instruction 316, that is associated with the route 106 that was obtained in operation 581 and which is being followed by the driver 236 of the vehicle 230 during operation of the vehicle 230 under manual control.

The first location along the roadway 252 represents the location at which the navigation instruction is to be acted on. Thus, the driver 236 of the vehicle 230 will need to take an action corresponding to the navigation instruction at the first location in order to continue following the route 106. Otherwise, the vehicle 230 may leave the route 106, resulting, for example, in recomputation of the route 106 by the navigation system 100. As an example, the navigation instruction obtained in operation 582 may be a point at which the navigation instructions 116 instruct the vehicle 230 to turn onto a different roadway in order to continue following the route.

The process 580 is applicable to a situation where the roadway 252 defines multiple lanes, such as the left lane 453a, the center lane 453b, and the right lane 453c, and the navigation instruction obtained in operation 582, regarding the action to be taken, specifies a first lane (e.g., the right lane 453c) from the multiple lanes. This information, specifying a first lane from the multiple lanes, indicates that the vehicle 230 should be positioned in the specified lane in order for the driver 236 of the vehicle 230 to successfully follow the navigation instruction obtained in operation 582. It is noted that the term “first” is used here as a term of convenience to distinguish between different lanes of the roadway 252, and does not indicate a particular location for the first lane from the multiple lanes of the roadway 252.

Operation 583 includes also include obtaining a first image of the roadway 252 from an imaging device that is located with the vehicle 230 while the vehicle 230 is travelling along the roadway 252 toward the first location. The first image of operation 583 may be, for example, the first image 312a as previously described. The imaging device in operation 583 may be the sensor 246 or the imaging device 346 as previously described. Thus, for example, the imaging device used in operation 583 may be a still camera or a video camera. The images obtained by the imaging device in operation 583 depict the roadway 252, as described with respect to the sensor 246 and the field of view 250. In some implementations of the process 580, the imaging device is integrated with the vehicle 230, as described with respect to the sensor 246 and the vehicle 230 in connection with the implementation shown in FIGS. 2A-2B. In some implementations of the process 580, the personal device 256 incorporates the imaging device used in operation 583, as described with respect to the sensor 246 and the personal device 256 in connection with the implementation shown in FIG. 2C.

Operation 584 includes determining, based on the first image from operation 583, that the vehicle 230 is located in a second lane (e.g., the left lane 453a or the center lane 453b) from the multiple lanes of the roadway 252. Here, the second lane from the multiple lanes of the roadway 252 is a lane other than the first lane, which is specified by the navigation instruction of operation 582 as the correct lane for the vehicle 230 to be positioned in upon reaching the first location, at which the navigation instruction of operation 582 specifies an action to be taken by the vehicle 230 (e.g., as a result of a control input provided by the driver 236 of the vehicle 230 using the operator controls 234) so that the vehicle 230 continues following the route 106.

Operation 585 includes, in response to determining that the vehicle is located in the second lane in operation 584, outputting a first notification that instructs the driver 236 of the vehicle 230 to move the vehicle 230 to the first lane. The first notification of operation 585 may be output in the manner described with respect to the notifications 118 and the first notification 318a.

In some implementations, as described with respect to the lane confirmation subsystem 360, outputting the first notification in operation 585 is performed when a distance between the vehicle and the first location is less than a first threshold distance. The first threshold distance may be determined based on a speed of the vehicle. The first threshold distance may be determined based on a traffic condition on the roadway. The first threshold distance may be determined based on a preference of the driver 236. The first threshold distance may be determined based on a driving style of the driver 236, such as an average of time the driver uses to change lanes.

The process 580 may include optional operations 586, 587, and 588. Operation 586 is performed subsequent to outputting the first notification, and includes obtaining a second image of the roadway 252 from the imaging device (e.g., the imaging device 346). Operation 587 includes determining, based on the second image, that the vehicle 230 has moved from the second lane to the first lane. This indicates that the vehicle 230 is not positioned in the correct lane of the roadway 252 according to the navigation instruction from operation 582. In response to determining that the vehicle 230 has moved to the first lane in operation 587, operation 588 includes outputting a second notification that indicates that the vehicle 230 is positioned correctly.

In some implementations, the imaging device used in the process 580, such as the imaging device 346, is powered off when a distance between the vehicle 230 and the first location is greater than a second threshold distance, and the imaging device is powered on in order to obtain the first image when the distance between the vehicle 230 and the first location is less than the second threshold distance. The second threshold distance may be greater than the first threshold distance.

In the process 580, notifications, such as the first notification and the second notification, may include an audio notification, a visual notification, or a haptic notification. The first notification and the second notification may be output using an output device associated with the vehicle 230. The first notification and the second notification may be output using a personal electronic device, such as the personal device 256, that is associated with the driver 236 of the vehicle 230, and the personal electronic device may incorporate the imaging device used to obtain the first and second images. In some implementations, obtaining the navigation instruction, obtaining the first image, determining that the vehicle 230 is located in the second lane (e.g., not in the correct lane), and outputting the first notification are performed by the personal electronic device. In some implementations, the first notification and the second notification are output using a wearable device that is worn by the driver 236 of the vehicle 230, such as the wearable device 254. In some implementations, the imaging device or other sensor used to observe the roadway 252 and identify lanes in the process 580 is integrated with the vehicle 530.

Although the process 580 is described as using an imaging device that obtains images, it should be understood that other sensing modalities may be used to identify locations of lanes on the roadway 252 and determine whether the vehicle 230 is in the correct lane. As one example, signals from a lidar sensor may be used to identify the locations of raised pavement markings or recessed pavement markings, and identify lane locations based on the locations of such markings. As another example, high-accuracy position information regarding the location of the vehicle 230 with respect to known locations of lanes of the roadway 252 may be used to determine which lane the vehicle 230 is travelling in, and to determine whether the lane that the vehicle is travelling in is the correct lane according to the navigation instructions 116.

FIG. 6 is a block diagram that shows an example of a hardware configuration for the example computing device 690, which can be used to implement devices that are described herein, such as the vehicle 230, the infotainment system 232, the wearable electronic device 254, and the personal device 256. In the illustrated implementation, the computing device 690 includes one or more processors 691, a memory 692, a storage device 693, and input/output devices 694.

The one or more processors 691 are operable to execute computer program instructions and are operable to perform operations that are described by the computer program instructions. The one or more processors 691 may be implemented using one or more conventional devices and/or more or more special-purpose devices. The memory 692 may be one or more volatile, high-speed, short-term information storage devices such as random-access memory modules. The storage device 693 is intended to allow for long term storage of computer-executable program instructions and other data. Examples of suitable devices for use as the storage device 693 include non-volatile information storage devices of various types, such as a flash memory module, a hard drive, or a solid-state drive. The input/output devices 694 allow communication of the computing device 690 with components of the devices described herein and with conventional components, and may include a bus, a wired interface, a wireless interface, or other interface by which devices can communicate.

As described above, one aspect of the present technology is the gathering and use of data available from various sources for use during navigation from an origin to a destination. As an example, such data may identify the location of a user and a lane of travel. The present disclosure contemplates instances where this gathered data beneficially assists a user in reaching their destination. However, implementers are reminded that, to the extent user identification data that uniquely identifies or can be used to contact or locate a specific person, that such information should be handled with respect to appropriate privacy policies and privacy practices. Entities should implement and consistently use privacy policies and practices that are generally recognized as meeting or exceeding industry or governmental requirements for maintaining personal information data private and secure.

Privacy policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. The present disclosure also contemplates embodiments in which users selectively block the use of, or access to, personal information data. That is, the present disclosure contemplates that hardware and/or software elements can be provided to prevent or block access to such personal information data. For example, in the case of storing a user profile for navigation, the present technology can be configured to allow users to select to “opt in” or “opt out” of participation in the collection of personal information data during registration for services or anytime thereafter. In another example, users can select not to provide data regarding usage of specific applications. In yet another example, users can select to limit the length of time that application usage data is maintained or entirely prohibit the development of an application usage profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. Data de-identification may be facilitated, when appropriate, by removing specific identifiers (e.g., names, etc.), controlling the amount or specificity of data stored (e.g., collecting location data at a city level rather than at an address level), controlling how data is stored (e.g., aggregating data across users), and/or other methods.

What is claimed is:

1. A non-transitory computer-readable storage device including program instructions executable by one or more processors that, when executed, cause the one or more processors to perform operations, the operations comprising:
obtaining a navigation instruction that is associated with a first location along a roadway, wherein the roadway defines multiple lanes, and the navigation instruction specifies a first lane from the multiple lanes;
obtaining a first image of the roadway from an imaging device that is located with a vehicle that is travelling along the roadway toward the first location;
determining, based on the first image, that the vehicle is located in a second lane from the multiple lanes; and
in response to determining that the vehicle is located in the second lane, outputting a first notification that instructs a driver of the vehicle to move the vehicle to the first lane.

2. The non-transitory computer-readable storage device of claim 1, wherein outputting the first notification is performed when a distance between the vehicle and the first location is less than a first threshold distance.

3. The non-transitory computer-readable storage device of claim 2, wherein the first threshold distance is determined based on a speed of the vehicle.

4. The non-transitory computer-readable storage device of claim 2, wherein the first threshold distance is determined based on a traffic condition on the roadway.

5. The non-transitory computer-readable storage device of claim 2, wherein the imaging device is powered off when a distance between the vehicle and the first location is greater than a second threshold distance, and the imaging device is powered on in order to obtain the first image when the distance between the vehicle and the first location is less than the second threshold distance.

6. The non-transitory computer-readable storage device of claim 5, wherein the second threshold distance is greater than the first threshold distance.

7. The non-transitory computer-readable storage device of claim 1, further comprising:
subsequent to outputting the first notification, obtaining a second image of the roadway from the imaging device;
determining, based on the second image, that the vehicle has moved from the second lane to the first lane; and
in response to determining that the vehicle has moved to the first lane, outputting a second notification that indicates that the vehicle is positioned correctly.

8. The non-transitory computer-readable storage device of claim 1, wherein the first notification includes an audio notification.

9. The non-transitory computer-readable storage device of claim 1, wherein the first notification includes a visual notification.

10. The non-transitory computer-readable storage device of claim 1, wherein the first notification includes a haptic notification.

11. The non-transitory computer-readable storage device of claim 1, wherein the first notification is output using an output device associated with the vehicle.

12. The non-transitory computer-readable storage device of claim 1, wherein the first notification is output using a personal electronic device that is associated with the driver of the vehicle, and the personal electronic device incorporates the imaging device.

13. The non-transitory computer-readable storage device of claim 12, wherein obtaining the navigation instruction, obtaining the first image, determining that the vehicle is located in the second lane, and outputting the first notification are performed by the personal electronic device.

14. The non-transitory computer-readable storage device of claim 1, wherein the first notification is output using a wearable device that is worn by the driver of the vehicle.

15. The non-transitory computer-readable storage device of claim 1, wherein the imaging device is integrated with the vehicle.

16. An apparatus, comprising:
a memory; and
one or more processors that are configured to execute instructions that are stored in the memory, wherein the instructions, when executed, cause the one or more processors to:
obtain a navigation instruction that is associated with a first location along a roadway, wherein the roadway defines multiple lanes, and the navigation instruction specifies a first lane from the multiple lanes;
obtain a first image of the roadway from an imaging device that is located with a vehicle that is travelling along the roadway toward the first location;
determine, based on the first image, that the vehicle is located in a second lane from the multiple lanes; and
in response to determining that the vehicle is located in the second lane, output a first notification that instructs a driver of the vehicle to move the vehicle to the first lane.

17. The apparatus of claim 16, wherein the instructions cause the one or more processors to output the first notification when a distance between the vehicle and the first location is less than a first threshold distance.

18. The apparatus of claim 17, wherein the first threshold distance is determined based on at least one of a speed of the vehicle or a traffic condition on the roadway.

19. The apparatus of claim 17, wherein the imaging device is powered off when a distance between the vehicle and the first location is greater than a second threshold distance, and the imaging device is powered on in order to obtain the first image when the distance between the vehicle and the first location is less than the second threshold distance, and the second threshold distance is greater than the first threshold distance.

20. A method, comprising:
obtaining a navigation instruction that is associated with a first location along a roadway, wherein the roadway defines multiple lanes, and the navigation instruction specifies a first lane from the multiple lanes;
obtaining a first image of the roadway from an imaging device that is located with a vehicle that is travelling along the roadway toward the first location;
determining, based on the first image, that the vehicle is located in a second lane from the multiple lanes; and
in response to determining that the vehicle is located in the second lane, outputting a first notification that instructs a driver of the vehicle to move the vehicle to the first lane.
